(19) United States
(12) Patent Application Publication
(10) Pub. No.: US 2005/0076771 A1
(43) Pub. Date: Apr. 14, 2005

(54) Method of conveying musical information

(76) Inventor: Patricia Carlson, Friendsville, TN (US)

Correspondence Address: Intellectual Property Department;DEWITT ROSS & STEVENS S.C., US Bank Building, 8000 Excelsior Drive, Suite 401, Madison, WI, 53717-1914, US

(21) Appl. No.: 10/727,368

(22) Filed: Dec. 4, 2003

Related U.S. Application Data
(60) Provisional application No. 60/431,111, filed on Dec. 5, 2002.

(51) Int. Cl. G10H 1/38; G10H 7/00

(52) U.S. Cl. 84/613

(57) ABSTRACT

Disclosed is a method of conveying musical information. The method includes the steps of assigning sequential numeric designations to primary, ionian musical tones, and modeling a musical passage comprised of a series of tones by compiling a pattern of printed or electronically-stored indicia of two or more of the numeric designations, the pattern corresponding to the series of tones of the musical passage. The modeled passage is then presented to a student via visual or auditory means.

### CROSS-REFERENCE TO RELATED APPLICATION

Priority is hereby claimed to provisional application Ser. No. 60/431,111, filed Dec. 5, 2002, the entire content of which is incorporated herein.

### FIELD OF THE INVENTION

The invention is directed to a method of teaching musical theory, composition, and performance by relating musical tonality and form to a numerical scheme that is easily understood by children and easily visualized using a standard piano keyboard.

### BACKGROUND

Music is often referred to as a “universal language.” But the ability to convey musical ideas from one human to another is not “universal,” and there are many different “languages” in which to convey such ideas. “Language” as used in the present application denotes a systematic means of communicating ideas or feelings by the use of conventional signs, sound, gestures, or marks having understood meanings. In other words, a functional language necessarily encompasses accepted conventions that are understood by the target audience. As a consequence, while “music” itself is a universal phenomenon, the conventional “languages” or nomenclatures used to define, teach, convey, and compose musical ideas are far from universal.

For example, in western music, tonality is designated using seven alphabetic designations, i.e., the notes A, B, C, D, E, F, and G. Five additional tones are defined as being “sharps” (#) or “flats” (b) of the seven alphabetic designations. Thus, a conventional piano or organ keyboard includes the additional five notes: C-sharp/D-flat, D-sharp/E-flat, F-sharp/G-flat, G-sharp/A-flat, and A-sharp/B-flat.

These 12 tones and octaves of these tones are used to generate the entire panoply of western music. Thus, the conventional western-style language of western music is fundamentally alphabetical. For example, an orchestral work can be defined by its “key,” (i.e., it's predominate tonality) such as a symphony in the key of D. Additional designations may also attach, such as whether the work is in a “major key” or a “minor key.”

Certain western music can also be defined as being “modal,” that is, as falling within a given “mode.” There are seven distinct modes in western music. The seven modes can be easily envisioned as corresponding to the seven scales that begin on one of the seven alphabetically-designated tonalities.
C=Ionian=a scale played: C D E F G A B
D=Dorian=a scale played: D E F G A B C
E=Phrygian=a scale played: E F G A B C D
F=Lydian=a scale played: F G A B C D E
G=Mixolydian=a scale played: G A B C D E F
A=Aeolian=a scale played: A B C D E F G
B=Locrian a scale played: B C D E F G A.

Thus, while the seven notes played in each of the modes illustrated above are the same notes, they are played in different order, and it is this order that gives each mode a distinct musical texture. All of these scales contain the same notes, but they are also different modes of different keys. That is, they are all relative scales. For example “A Aeolian” is the conventional A minor scale. As with the definition of the tones themselves, modal music is also conventionally defined and taught within the confines of alphabetic designations.

These alphabetic designations are daunting both to beginning students and more advanced students alike. In short, the alphabetic-based nomenclature and symbols used conventionally to convey western musical compositions are accurate, precise, and the subject of a vast body of pedagogical literature. However, the conventional nomenclature is cumbersome, non-systematic, unfamiliar, and far less than ideal for instructing beginning and novice music students. For example, a simple concept like the interval between two notes is not easily conveyed alphabetically; e.g., how many tones are there between C and F? A quick look at a keyboard indicates four notes between C and F. But the nomenclature itself does not quickly convey that information. Nor does the nomenclature provide any systematic guidance regarding, for example, the relationships between the various modes and keys.

Other conventional musical nomenclatures, such as the notation used in traditional Japanese music (Gagaku, Sokyoku, and the like) are entirely distinct from western-style nomenclature, and equally intractable to beginning and novice students alike.

A long-felt and unsolved need in the music instruction industry, then, is a method whereby musical proficiency (in hearing, learning, performing, and composing music) can be instilled quickly and easily, with maximum understanding and retention of the underlying concepts that yield the full scope of western music.

### SUMMARY OF THE INVENTION

The invention is directed to a method of denoting, storing (in written or electronic format) and conveying (by written, printed, or otherwise displayed indicia) musical information via numeric indicia. The method comprises assigning sequential numeric designations to primary, ionian musical tones, the sequential numeric designations corresponding to sequential musical intervals found in an ionian scale, thereby yielding seven distinct numeric designations. Once the numeric designations have been assigned, a musical passage comprised of a series of tones is modeled by compiling a pattern of printed or electronically-stored indicia of two or more numeric designations selected from the group consisting of the seven distinct numeric designations, the pattern corresponding to the series of tones of the musical passage. The model is then provided to a student via written, printed, or electronic visual means or auditory means (e.g., via recordings or spoken voice).

In the preferred embodiment, the sequential numeric designations 1, 2, 3, 4, 5, 6, and 7 are assigned and these designations are assigned respectively to the ionian musical tones do, re, mi, fa, so, la, and ti.

In a particularly preferred embodiment, the method further comprises assigning sequential numeric chord designations corresponding to the numeric designations 1, 2, 3, 4, 5, 6, 7, wherein each sequential chord designation uniquely denotes a three-note cluster of tones as follows: chord designation 1 denotes tones 1, 3, and 5; chord designation 2 denotes tones 2, 4, and 6; chord designation 3 denotes tones 3, 5, and 7; chord designation 4 denotes tones 4, 6, and 1; chord designation 5 denotes tones 5, 7, and 2; chord designation 6 denotes tones 6, 1, and 3; and chord designation 7 denotes tones 7, 2, 4.

The indicia used in the present invention can be memorialized via hand-writing, printing, or storage in electronic or electromagnetic media, such as a programmable computer, CD device, DVD device, magnetic tape, magnetic disk, etc. (i.e., via any means now known in the art or developed in the future for fixing indicia in a tangible medium of expression). In this sense, “modeling” the musical passage is synonymous with “scoring” the musical passage. That is, the passage is memorialized, recorded, stored, and transmitted not in the traditional nomenclature of western music, but in the numeric language disclosed herein. The entire musical passage is modeled numerically, as a series of numbers, rather than as a series of letters or notes on a traditional five-line staff.

The Numeric Language of Music is ideal for modeling existing musical works and passages (both as a pedagogical tool for shorter, student-oriented pieces and as a systematic nomenclature for full-blown orchestral scores). The language can also be used as a compositional tool to record and convey new musical compositions.

### BRIEF DESCRIPTION OF THE DRAWINGS

FIG. 1 is a rendering of a portion of a piano keyboard showing the conventional alphabetic designations for the various white keys.

FIG. 2 is a rendering of a portion of a piano keyboard showing the numeric designations for the white keys according the method of the present invention.

### DETAILED DESCRIPTION OF THE INVENTION

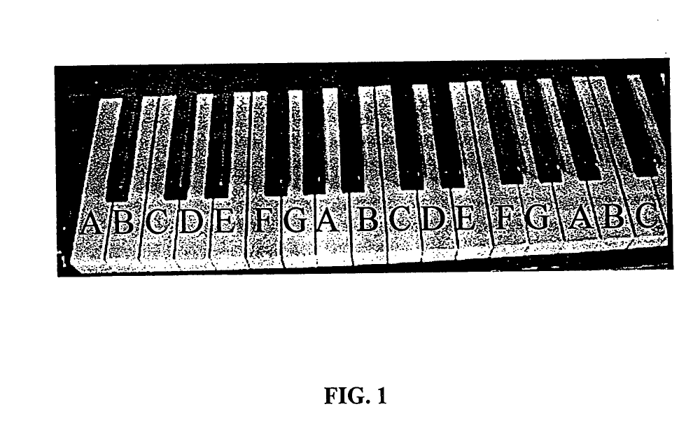

The piano is a fine instrument on which to learn and to teach music. The primary advantage of the piano as a teaching tool is that the layout of its keys provides a simple visual model with which to convey musical ideas. As noted above, the white keys of a piano are given the alphabetic designations A, B, C, D, E, F, and G. Starting from the far left-hand side of a standard, 88-key piano, the white keys begin with the “A” key, with each subsequent key being assigned the next alphabetic designation up to “G,” at which point, the lettering scheme begins again. See FIG. 1. Thus, the seven letters of the alphabet used to identify the seven primary tones in western music are represented by the white keys of the piano in perfect sequential order. The seven lettered tones then repeat themselves in the next octave of notes.

The black keys of a piano are grouped systematically by twos and threes. The grouping of two black keys correspond to C#/D♭ and D#/E♭, while the grouping of three black keys correspond to F#/G♭, G#/A♭, and A#/B♭.

The term “octave” is, at least symbolically, critical to grasping the method of the present invention. The word “octave” literally means “eight” in Latin. Notes separated by an octave are the same note, having the same fundamental pitch, but separated by an integral wavelength (i.e., a first note that is one octave lower than a second note has a wavelength twice as long as the second note).

In the present method, rather than using the alphabet to define critical musical relationships and concepts, numbers are used. Thus, the present invention is referred to herein as “The Numeric Language of Music.” Numbers have been used in the past to convey musical ideas, but not in a systematic framework that aids in teaching and composition of musical works. For example, thousands of years ago, Pythagoras (ca. 530 BC) observed the harmonious relationship of tones in ratios of simple numbers. Thus, the base tone of a plucked string, for example, will generate a series of natural harmonics that are integral ratios of the length of the string: e.g. shorten the string by half (a 2:1 ratio) and the resulting tone is an octave higher than the base tone; a 3:2 ratio yields a perfect fifth; a 5:4 ratio yields a major third, etc. But these mathematical intervals (octaves, fifths, thirds) are natural phenomena, not a pedagogical tool.

In contrast, the standard piano keyboard can be used as a pedagogical tool. Note that the conventional and familiar system of 12 equally-spaced tones between octaves (i.e., the 12 black and white keys that define an octave on a piano) is a compromise with nature. The piano keyboard does not mirror exactly the natural mathematical relationships between tones first articulated by Pythagoras. The natural harmonic scale, as described in the previous paragraph, is ideal for music that stays in the same mode (e.g., most Eastern-style music). Western music, however, often switches between modes. Therefore, the standard western chromatic scale as exemplified by a piano keyboard, is of “equal temperament.” An octave is divided into 12 tones, the musical “space” between each of which is identical. This system strikes a now long-accepted compromise between preserving as many of the natural harmonic relationships as possible, while maintaining economy, efficiency, and maneuverability.

In the Numeric Language of Music, rather than using letters to define the various basic tonalities, numbers are used. For sake of brevity and simplicity, in the discussion that follows, the Numeric Language will be defined and explained in the key of C. This is for brevity only.

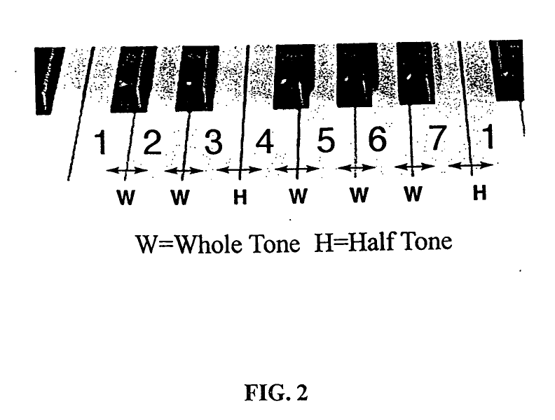

Referring now to FIG. 2, in the Numeric Language of Music, the seven basic tonalities are defined using the numbers 1, 2, 3, 4, 5, 6, 7, starting with the note “C.” In this context, the term “in the key of” now becomes significant when the applied meaning is to identify which alphabetic tone (e.g., “C”) is equal to the number 1 in the Numeric Language of Music. There are only seven primary tones in a major (i.e., ionian) scale. The fact that there are only seven primary tones is used to construct, for purposes of musical instruction, a numerical vocabulary for describing the relationships between all aspects of music, including standard scales, altered scales, modes, etc. In short, the entire realm of western musical instruction can be simplified throughout to a unitary numerical schematic that utilizes only seven primary tones. Rather than committing arbitrary terms and their meanings to memory (e.g., locrian, phrygian, etc.), the student need only memorize and apply numeric relationships that yield harmonically pleasing sounds.

As noted above, while the discussion that follows is limited to a discussion of the key of “C,” it is easily moved up or down the musical scale into any other key. Thus, in the first step of the present method, sequential numeric designations are assigned to the primary musical tones of a major scale (i.e., the tones do, re, mi, fa, so, la, and ti in the Solfeggio nomenclature). As noted above, these sequential numeric designations correspond to the conventional, alphabetically-designated primary musical tones C, D, E, F, G, A, and B (in the key of C). This yields seven distinct numeric designations, 1 through 7. As detailed below, it does not matter which actual note is designated as “1.” In this example, it is “C.” But the nomenclature of The Numeric Language of Music applies with equal force if any other note is chosen as the starting point (i.e., any primary tone can be designated as “1,” with the remaining tones being designated 2-7 in ascending order as represented by the white keys on a piano).

In the key of “C,” each white key of the piano represents one specific, numerically-designated tone:
1=C=do
2=D=re
3=E=mi
4=F=fa
5=G=so
6=A=la
7=B=ti.

The same applies for every other key. Thus, referring again to FIG. 2, if all 12 keys (white and black) in a single octave are taken into account, there is a half-step between each adjoining key. That is, there is a half-step interval between C and C#, C# and D, D and D#, D# and E, and E and F, etc. Note that there is no black key between E and F and B and C. FIG. 2 illustrates the interval relationship in The Numerical Language of Music between the tones 1, 2, 3, 4, 5, 6, 7. In short, there is a whole-step interval between tones 1 and 2, 2, and 3, 4 and 5, 5 and 6, and 6 and 7; and a half-step interval between tones 3 and 4, and between 7 and 1 of the next higher (or lower) octave.

This relationship of whole- and half-tones is maintained when The Numeric Language is applied to music in a key other than C. Thus, for example, if the tone conventionally designated as “D” or “re” is designated as no. 1, The Numeric Language of Music assigns the following numeric values to the ionian scale in D:
1=D=do
2=E=re
3=F# (thus giving a whole step interval between tones 2 and 3)=me
4=G=fa
5=A=so
6=B=la
7=C# (thus giving a whole step interval between tones 6 and 7)=ti.

The same interval relationship applies to all of the other major scales, regardless of whether the starting tone, tone 1, is a white key or a black key. In every instance, there is a whole-step interval between tones 1 and 2, 2, and 3, 4 and 5, 5 and 6, and 6 and 7; and a half step interval between tones 3 and 4, and between 7 and 1 of the next higher (or lower) octave.

Of critical importance in the present system is that the numeric designations are independent of key and independent of mode. The relationship of the intervals between the tones 1-7 is the same, regardless of the key or mode chosen. The result, The Numeric Language of Music, thus provides a systematic means for identifying, understanding, and conveying which musical intervals (as designated by a series of numeric indicia) result in music aimed to deliver an intended “message” (e.g., discord vs. harmony, angst vs. peace, uncertainty vs. resolution, motion vs. rest, etc.).

The Numeric Language of Music is thus a system wherein a student is first taught numerical designations that can then be used to make numerical phrases that correspond to desirable musical sounds. In effect, the numerical designations empower a student or teacher of western music to create a numerical music vocabulary for conveying musical ideas and feelings. The vocabulary begins at the most basic level by compiling two or more numeric designations selected from the seven distinct numeric designations to create a model or a pattern corresponding to the series of tones of a desired musical passage. In effect, musical “equations” are created. These musical equations can then be used to convey entire musical works simply and quickly.

As noted earlier, the beauty and ease of The Numeric Language of Music is that the interval relationships between the tones 1 through 7 remain constant, regardless of the key in which the music is couched. This is not the case in music fixed in a tangible medium according to the standard western alphabetic nomenclature or in modal music. By definition, the interval relationships between the tones in any given mode are different than in all of the other modes. This fact is what makes traditional western musical notation and nomenclature so frustrating to the beginner: there is no systematic nomenclature or vocabulary that translates obscure musical designations such as “locrian” or “mixolydian” to a mathematical understanding of the musical intervals that actually define either of these two modes (or any of the other modes). The same frustration is encountered with non-systematic designations such as the “key of B” or the “key of G.” In The Numeric Language of Music, however, transposition, in the traditional sense of playing a song written in, say, the key of C, in some other key, is irrelevant. The interval relationships between the tones designated 1 through 7 remain the same, regardless of key.

Thus, the first step in the present process is to assign ascending sequential integers to the 7 primary tones (do, re, me, fa, so, la, ti, do) of conventional western music, starting on any primary tone.

A corresponding set of three-tone chords is then designated using the same set of ascending sequential integers to the 7 primary chords. Thus, in The Numeric Language of Music, there are seven primary chords that correspond to the seven numeric designations for the primary tones. Each of the seven primary chords is formulated by selecting three alternating tones from among the seven primary tones, as follows:
The “1” chord=tones 1, 3, 5
The “2” chord=tones 2, 4, 6
The “3” chord=tones 3, 5, 7
The “4” chord=tones 4, 6, 1*
The “5” chord=tones 5, 7, 2*
The “6” chord=tones 6, 1, 3*
The “7” chord=tones 7, 2, 4*.
   * Designates tone one octave higher than the “1” tone.

Because the musical intervals between each individual numerical tone are defined, the seven primary chords, designated numerically, each denotes a specific musical relationship in and of themselves. Thus, for example, the “1” chord, the “4” chord, and the “5” chord each correspond to a major triad (using traditional nomenclature). The “2” chord, however, corresponds to a minor triad (using traditional nomenclature).

In the present invention, the set of numbers used to designate the primary tones is akin to the alphabet. The corresponding set of numbers used to designate the primary chords is akin to a small dictionary of available words. The primary benefit of the present invention is that in The Numeric Language of Music, rather than cluttering a student's head with arbitrary, non-systematic, confusing, and wholly unnecessary nomenclature (e.g., major, minor, ionian, dorian, phrygian, etc.), a simple numeric designation is used both to teach and to represent the very heart of the required musical information. The musical passage to be taught, thus, is modeled using number alone. Thus, in The Numeric Language of Music, the simple instruction “Play the 5 chord” immediately tells the student to “play the chord corresponding to the tones 5, 7, and 2. In traditional parlance, this same instruction requires using three separate descriptors (a key, a mode, and a number), and thus the corresponding traditional instruction would be “Play a “G major triad.” The information “overkill” in the traditional system simply is not conducive to transmitting musical information quickly and easily.

In a similar fashion, designating chord inversions is far simpler in The Numeric Language of Music than it is in traditional nomenclature. Thus, the “1” chord is inverted to yield the 1′ inversion by simply telling the student to use the same three notes (1, 3, and 5) and placing the 3 note as the lowest-pitched of the three, the 5 note as the middle pitch, and the 1 note as the highest-pitched of the three. Similarly, the 2nd inversion of the “1” chord also uses the same three notes, with the exception that the 5 note is the lowest-pitched, the 1 note is in the middle, and the 3 note is the highest-pitched. The system thus yields 21 distinct primary chord voicings: the 7 primary tri-tone chords and two inversions each.

The same method of generating inverted chords applies to each of the other numerically-designated chord types (i.e., chords “2” through “7”). In this fashion, it is remarkably easy to convey very complex musical relationships quickly, even to beginners. Beginners need not become flustered with both mastering a new instrument and mastering an unfamiliar lexicon all at the same time. Everybody, even most three-year olds, can count to seven. And that is really all that is required to master the intricacies of The Numeric Language of Music.

Every style of music, including jazz, blues, country, gospel, reggae, rap, classical, ragtime, etc., has a distinctive sound that can be modeled, recorded, stored, and conveyed to a student using The Numeric Language of Music. Thus, musical understanding and composition is simplified to the point of simply combining the numbers 1 through 7 in archetypal sequences to yield music that sounds “correct” for the chosen musical style.

For example, the numeric relationship of the individual notes and chords, coupled with the rhythm, conveys musical imagery and emotional content. Thus, literally any piece of music that ends in the “6” chord, regardless of key, will inevitably evoke feelings of sadness, foreboding, doom, and/or seriousness. In contrast the musical motion going from 1 to 4 to 1 (either individual notes or from the “1” chord, to the “4” chord, and then back to the “1” chord) evokes elation, pomp, or grandeur. If the 7 tone is emphasized melodically in a passage containing 6, 4, or 5 in the bass line, a feeling of longing is evoked. Traditional country music closely adheres to a formulaic construction combining the 5 tone with the 1, 2, and 3 tones of the Numeric Language.

Nor is The Numeric Language of Music limited to popular music. Thus, for example, in a typical classical score of the romantic period, the cellos plays 6 in the bass line, violas and violins play the three tones of the “6” chord (typically in 8th˜note rhythm), and woodwinds play the melody. As the score moves from bar to bar, The Numeric Language of Music provides an easily recognizable formula (i.e., easily recognized both aurally—by listening, and in written notation) for reconstructing a similar musical feeling or image utilizing the same or similar interval relationships and numeric sequences.

Thus, a melodic theme is taught according to the present invention by connecting selected tones of the numeric alphabet and associating the selected tones with patterns of rhythm to create a musical phrase. Musical phrases are connected in a way to make whole “sentences” or themes. The phrases are designated and recorded (or otherwise written or stored) using the numeric indicia described earlier, to designate individual tones, chords, and inversions.

For example, in a simple passage, the student learns to move the chords in their first inversion through a simple numeric sequence model such as 1-6-4-5-1. When played in the root position, the lowest numeric tone of the chord is the numeric identity for the group of three tones which are combined to create the chord. The lowest tone of the chord is moved an octave higher to create the 1st inversion of the chord. This moves the tone which is the numeric identity of the chord from the lowest tone of the three-tone chord to the highest in the group of three notes. Similarly, in the 2nd inversion of any of the 7 primary chords, the tone that identifies the numeric designation of the chord is the middle tone of three-tone chord.

It is a further feature of the invention that once the student has become familiar with the numeric alphabet and the 7 chords of the key of C, he can then create a pattern for the left had to play. The pattern can be added to the students' vocabulary. The vocabulary is developed and becomes the foundation upon which a composition is built. In this aspect of the invention, for example the tones 1, 5, and 1 (an octave) are played with the left hand (on a piano) so that the pinky and the thumb play the same tone, one octave apart. The pinky is placed on 1 and the hand stretched to play the same tone an octave higher with the thumb. When the left hand is stretched a full octave, the index finger naturally falls on the 5 tone.

The invention can also be used to teach music composition. Composing music may be dramatically simplified through the translation of the musical terms to the simple numeric language disclosed herein. For example, the numeric vocabulary of country music is combined with a 3-beat rhythm to create a waltz. With the left hand playing the ¾ rhythm pattern of the waltz, and the right hand playing the basic vocabulary of country music, the result is a classic “country waltz.” Thus, an example of the combined vocabulary would be modeled (or designated or scored) as follows:
1-4-1-5-1-4-1-5-1-4/2-1-4-1-5-1-5-1-4/2-1-4-1-5-1.

In short, the selection of specific numeric tones from the musical alphabet combine in a way which clearly distinguishes the vocabulary used to compose the different formats of music literature.

The effectiveness of understanding how specific numeric tones combine to create the vocabulary of music literature according to the present inveniton is clearly exemplified by studying the style of music referred to as the “blues.” The numeric tone which identifies music as being the “blues” is the flat 7 tone. With the basic concept of the 7 primary tones and 7 primary chords (and their inversions) in hand, all that must be done is to locate the flat 7 in relation to the 1 chord. When the flat 7 is combined with the 1 chord, it can be moved up and down the keyboard in any inversion, and yield a definitively “bluesy” feel.

The invention also provides an easy means to translate famous compositions into numerical notation. The famous German Christmas carol Silent Night can be used as an example. In this example, the structural foundation of the music form is the primary chord. The chord is modeled through the following numeric sequence:
1/1/5/1/4/1/4/1/5/1/1-5/1

If the primary chords are played in their root position in the numeric sequence with the left hand (on a piano) and the melody with the right-hand, a basic arrangement of the song Silent Night results. Musical arrangements are developed through having multiple choices of vocabulary, such as inversions of chords, alteration of left-hand rhythms and patterns, etc. Similarly, the gospel song, Amazing Grace is modeled (or scored) according to the present invention as follows: 1/1 flat 7/4/1/1/1/5/1/1 flat 7/4/1/6/5/1.

As with Silent Night, the basic arrangement of the song would be played with the primary chords with the left hand and the melody with the right hand. However, as the student becomes more proficient the left hand can elaborate by creating a rhythm using the first and fifth tones of the chord, octaves, etc.

Rhythmic relationships can also be conveyed and modeled using The Numeric Language. In a fashion corresponding to the seven primary tones, in western music all rhythmic relationships are represented by seven primary time designations or notes (used alone and in various combinations). In short, every single western composition is modeled in conventional format using a combination of seven different notes: the whole note, the half note, the quarter note, the eighth note, the sixteenth note, the 32^{nd} note, and the 64^{th} note. These notes are combined to form rhythms that are intervals between these divisions. The concept of “seven” therefore plays a central role in The Numeric Language of Music: seven primary tones and seven primary notes.

1. A method of conveying musical information, the method comprising:
(a) assigning sequential numeric designations to primary, ionian musical tones, the sequential numeric designations corresponding to sequential musical intervals found in an ionian scale, thereby yielding seven distinct numeric designations; and
(b) modeling a musical passage comprised of a series of tones by compiling a pattern of printed or electronically-stored indicia of two or more numeric designations selected from the group consisting of the seven distinct numeric designations of step (a), the pattern corresponding to the series of tones of the musical passage; and then
(c) providing the model of step (b) to a student via visual or auditory means.

2. The method of claim 1, wherein in step (a), the sequential numeric designations 1, 2, 3, 4, 5, 6, and 7 are assigned.

3. The method of claim 1, wherein in step (a), the sequential numeric designations 1, 2, 3, 4, 5, 6, and 7 are assigned respectively to the ionian musical tones do, re, mi, fa, so, la, and ti.

4. The method of claim 3, further comprising assigning sequential numeric chord designations corresponding to the numeric designations 1, 2, 3, 4, 5, 6, 7, wherein each sequential chord designation uniquely denotes a three-note cluster of tones as follows: chord designation 1 denotes tones 1, 3, and 5; chord designation 2 denotes tones 2, 4, and 6; chord designation 3 denotes tones 3, 5, and 7; chord designation 4 denotes tones 4, 6, and 1; chord designation 5 denotes tones 5, 7, and 2; chord designation 6 denotes tones 6, 1, and 3; and chord designation 7 denotes tones 7, 2, 4.

5. A method of conveying musical information, the method comprising:
(a) assigning sequential numeric designations 1, 2, 3, 4, 5, 6, and 7 respectively to primary, ionian musical tones do, re, mi, fa, so, la, ti, do, thereby yielding seven distinct numeric designations; and
(b) assigning sequential numeric chord designations corresponding to the numeric designations 1, 2, 3, 4, 5, 6, 7, wherein each sequential chord designation uniquely denotes a three-note cluster of tones as follows: chord designation 1 denotes tones 1, 3, and 5; chord designation 2 denotes tones 2, 4, and 6; chord designation 3 denotes tones 3, 5, and 7; chord designation 4 denotes tones 4, 6, and 1; chord designation 5 denotes tones 5, 7, and 2; chord designation 6 denotes tones 6, 1, and 3; and chord designation 7 denotes tones 7, 2, 4.
(c) modeling a musical passage comprised of a series of tones and chords by compiling a pattern of printed or electronically-stored indicia of two or more numeric designations and chord selected from the group consisting of the seven distinct numeric designations of step (a) and the seven distinct numeric chord designations of step (b), the pattern corresponding to the series of tones and chords of the musical passage; and then
(d) providing the model of step (b) to a student via visual or auditory means.

6. A method of conveying musical information, the method comprising:
(a) assigning sequential numeric designations to primary, ionian musical tones, the sequential numeric designations corresponding to sequential musical intervals found in an ionian scale, thereby yielding seven distinct numeric designations; and
(b) modeling a pre-existing musical passage comprised of a series of tones by compiling a pattern of printed or electronically-stored indicia of two or more numeric designations selected from the group consisting of the seven distinct numeric designations of step (a), the pattern corresponding to the series of tones of the pre-existing musical passage; and then
(c) providing the printed or electronically-stored indicia of step (b) to a student via visual or auditory means, from which the pre-existing musical passage is played by the student.

7. The method of claim 6, wherein in step (a), the sequential numeric designations 1, 2, 3, 4, 5, 6, and 7 are assigned.

8. The method of claim 6, wherein in step (a), the sequential numeric designations 1, 2, 3, 4, 5, 6, and 7 are assigned respectively to the ionian musical tones do, re, mi, fa, so, la, and ti.

9. The method of claim 8, further comprising assigning sequential numeric chord designations corresponding to the numeric designations 1, 2, 3, 4, 5, 6, 7, wherein each sequential chord designation uniquely denotes a three-note cluster of tones as follows: chord designation 1 denotes tones 1, 3, and 5; chord designation 2 denotes tones 2, 4, and 6; chord designation 3 denotes tones 3, 5, and 7; chord designation 4 denotes tones 4, 6, and 1; chord designation 5 denotes tones 5, 7, and 2; chord designation 6 denotes tones 6, 1, and 3; and chord designation 7 denotes tones 7, 2, 4.

10. A method of conveying musical information, the method comprising:
(a) assigning sequential numeric designations to primary, ionian musical tones, the sequential numeric designations corresponding to sequential musical intervals found in an ionian scale, thereby yielding seven distinct numeric designations; and
(b) modeling a musical passage comprised of a series of tones by compiling a pattern of printed or electronically-stored indicia of two or more numeric designations selected from the group consisting of the seven distinct numeric designations of step (a); and
(c) modeling a numeric sequence from which the musical passage is repeated by compiling a pattern of printed or electronically-stored indicia of two or more numeric designations selected from the group consisting of the seven distinct numeric designations of step (a); and then
(d) providing the model of step (c) to a student via visual or auditory means.
